(19) United States
(12) Patent Application Publication
(10) Pub. No.: US 2009/0268962 A1
(43) Pub. Date: Oct. 29, 2009

(54) Method and apparatus for blind source separation

(76) Inventors: Conor Fearon, Dublin (IE); Scott Rickard, County Dublin (IE); Thomas Melia, Dublin (IE)

Correspondence Address: THE NATH LAW GROUP, 112 South West Street, Alexandria, VA, 22314, US

(21) Appl. No.: 11/990,927

(22) PCT Filed: Aug. 25, 2006
(86) PCT No.: PCT/EP2006/008349

§ 371 Date: Feb. 25, 2008

(30) Foreign Application Priority Data
Sep. 1, 2005 (IE) S2005/0576

(51) Int. Cl. G06K 9/00; G10L 11/00

(52) U.S. Cl. 382/168; 704/200

(57) ABSTRACT

The Direction of Arrival estimation algorithm ESPRIT is capable of estimating the angles of arrival of N narrowband source signals using M>N anechoic sensor mixtures from a uniform linear array (ULA). Using a similar parameter estimation step, the DUET Blind Source Separation algorithm can demix N>2 speech signals using M=2 anechoic mixtures of the signals. The present invention demixes N>M speech signals using M>=2 anechoic mixtures.

### FIELD OF THE INVENTION

The present invention provides a method and apparatus for blind source separation (BSS).

### BACKGROUND OF THE INVENTION

The “cocktail party phenomenon” illustrates the ability of the human auditory system to separate out a single speech source from the cacophony of a crowded room, using only two sensors and with no prior knowledge of the speakers or the channel presented by the room. Efforts to implement a receiver which emulates this sophistication are referred to as Blind Source Separation techniques, examples of which are described by A. J. Bell and T. J. Sejnowski, “An information maximization approach to blind separation and blind deconvolution,” Neural Computation, vol. 6, pp. 1129-1159, 1995. no. 5, pp. 530-538, September 2004; P. Comon, “Independent component analysis: A new concept?” Signal Processing, vol. vol. 36, no. 8, pp. 287-314, 1994; and A. Hyvarinen, J. Karhunen, and E. Oja, “Independent component analysis,” Wiley Series on Adaptive and Learning Systems for Signal Processing, Communications and Control, 2001.

Generally, in the anechoic blind source separation model, N time-varying source signals s₁(t), s₂(t), . . . , s_{N}(t) propagate across an isotropic, anechoic (direct path), non-dispersive medium and impinge upon an array of M sensors which are situated in the far-field of all sources. Under such conditions the k^{th} mixture can be expressed as:

$${x}_{k} ( t ) = {\sum }_{i = 1}^{N} {a}_{ki} {s}_{i} ( t - {t}_{ki} ) + {n}_{k} ( t )$$

where aₖᵢ is attenuation of the i^{th} source at the k^{th} sensor and nₖ(t) is additive noise for the k^{th} sensor; and tₖᵢ is the delay from the i^{th} source to the k^{th} sensor.

Generally blind source separation algorithms attempt to retrieve or estimate the source signals s(t) from the received mixtures x(t) with little, if any prior information about the mixing matrix or the source signals themselves.

Typically blind source separation and direction of arrival techniques require the number of sensors to be greater than or equal to the number of sources M>=N.

Classic Direction of Arrival estimation techniques such as MUSIC disclosed by R. O. Schmidt, “Multiple emitter location and signal parameter estimation (MUSIC),” IEEE Trans. on Antennas and Propagation, vol. AP-34, no. 53, pp. 276-280, March 1986; and ESPRIT disclosed by R. Roy and T. Kailath, “ESPRIT—Estimation of Signal Parameters via Rotational Invariance Techniques,” IEEE Transactions on Acoustics, Speech and Signal Processing, vol. vol. 37, no. 7, pp. 984-995, July 1989 aim to find the N angles of arrival for N narrowband signals s₁(t), s₂(t), . . . , S_{N}(t) impinging upon an array of M sensors. With accurate estimation, beamforming can be performed to separate the N signals if M>=N.

For narrowband signals of centre frequency ω₀ a time lag can be approximated by a phase rotation, i.e. s(t−τ)≈s(t)exp{−jω₀τ}, where s(t) is the analytic representation of a real signal. As a result the k^{th} mixture can be expressed as

$${x}_{k} ( t ) = {\sum }_{i = 1}^{N} {a}_{ki} {e}^{- {jϖ}_{0} {t}_{ki}} {s}_{i} ( t ) + {n}_{k} ( t )$$

The ESPRIT algorithm relies on two subarrays of sensors. Each element of the first subarray is displaced in space from the corresponding element of the second subarray by the same displacement vector. It is also assumed that each signal source is sufficiently removed from the sensor arrays and so the time lag between the sensors of each pair for a source signal is constant.

Without loss of generality, in one common implementation of ESPRIT, it is assumed that the original sensor array is a uniformly spaced linear array consisting of M sensors, as a result the array of M sensors is subdivided into two subarrays of M−1 sensors each. The first subarray contains sensors 1, . . . , M−1 and the second subarray contains sensors 2, . . . , M.

The M−1 mixtures from the first array can be represented as

$$[ \begin{matrix}{x}_{1} ( t ) \\ {x}_{2} ( t ) \\ ⋮ \\ {x}_{m} ( t )\end{matrix} ] = [ \begin{matrix}{a}_{11} {e}^{- {jϖ}_{0} {t}_{11}} & … & {a}_{1 N} {e}^{- {jϖ}_{0} {t}_{1 N}} \\ {a}_{21} {e}^{- {jϖ}_{0} {t}_{21}} & … & {a}_{2 N} {e}^{- {jϖ}_{0} {t}_{2 N}} \\ ⋮ & & ⋮ \\ {a}_{m 1} {e}^{- {jϖ}_{0} {t}_{m 1}} & … & {a}_{mN} {e}^{- {jϖ}_{0} {t}_{mN}}\end{matrix} ] [ \begin{matrix}{s}_{1} ( t ) \\ ⋮ \\ {s}_{N} ( t )\end{matrix} ] + [ \begin{matrix}{n}_{1} ( t ) \\ {n}_{2} ( t ) \\ ⋮ \\ {n}_{m} ( t )\end{matrix} ] \\ x ( t ) = As ( t ) + {n}_{x} ( t ) \qquad ( 1 )$$

where the mixing matrix A has complex entries, each column may be associated with an individual narrowband source signal, and m=M−1 in the case of a uniform linear array. In the case where the sensors do not form a uniform linear array, M−1>m>=M/2, with m=M/2 if the two subarrays have no elements in common.

An estimate of the spatial covariance matrix

Rₓₓ=E{[x(t)][x(t)]^{H}} (2)

can be calculated, where H denotes a complex conjugate transpose operation. The Singular Value Decomposition (SVD) of Rₓₓ is of the form

$${R}_{xx} = {[ \begin{matrix}{E}_{s} & & {E}_{n}\end{matrix} ] [ \begin{matrix}Λ & 0 \\ 0 & Σ\end{matrix} ] [ \begin{matrix}{E}_{s} & & {E}_{n}\end{matrix} ]}^{H} \qquad ( 3 )$$

where Λ is a diagonal matrix with the N dominant entries associated with N signals, the M-N remaining singular values are comparable to the noise variance and are contained in the diagonal matrix Σ, the N column vectors of Eₛ are associated with the N dominant singular values and the M-N column vectors of Eₙ are associated with the M-N remaining singular values. The subspace spanned by Eₛ is known as the signal subspace and the orthogonal subspace spanned by Eₙ is known as the noise subspace.

The M−1 mixtures from the second array can be represented as

y(t)=A Φs(t)+n_{y}(t)

where the diagonal matrix

$$Φ = [ \begin{matrix}{e}^{- {jϖ}_{0} {δ}_{1}} & & \\ & ⋱ & \\ & & {e}^{- {jϖ}_{0} {δ}_{N}}\end{matrix} ]$$

contains delay terms δᵢ, i=1, . . . , N, which are unique to each source signal and are related geometrically to the angle of arrival, i.e. δᵢ=Δ cos(θᵢ)/c where Δ is the distance between the two subarrays, θᵢ is the angle of arrival of the i^{th} signal onto the array and c is the propagation speed.

Both data vectors can be stacked to form

$$[ z ( t ) ] = [ \begin{matrix}x ( t ) \\ y ( t )\end{matrix} ] = [ \begin{matrix}A \\ A Φ\end{matrix} ] [ s ( t ) ] + [ \begin{matrix}{n}_{x} ( t ) \\ {n}_{y} ( t )\end{matrix} ] \qquad ( 4 )$$

which is a 2 m-by-1 vector of mixtures. It follows that the SVD of the spatial covariance matrix R_{zz} can be computed

$${R}_{zz} = {[ \begin{matrix}{E}_{x} & {E}_{{n}_{x}} \\ {E}_{y} & {E}_{{n}_{y}}\end{matrix} ] [ \begin{matrix}Λ & 0 \\ 0 & Σ\end{matrix} ] [ \begin{matrix}{E}_{x} & {E}_{{n}_{x}} \\ {E}_{y} & {E}_{{n}_{y}}\end{matrix} ]}^{H}$$

For the no-noise case, the mixing matrix spans the same space as the signal subspace, i.e. there exists a non-singular matrix T such that

$$[ \begin{matrix}{E}_{x} \\ {E}_{y}\end{matrix} ] = [ \begin{matrix}A \\ A Φ\end{matrix} ] T \qquad ( 5 )$$

furthermore the diagonal matrix Φ is related to Eₓ^{†}E_{y} via a similarity transform

Φ=T[Eₓ^{†}E_{y}]T⁻¹ (6)

where ^{†} denotes the Moore-Penrose pseudo-inverse. As a result the N angles of arrival (θᵢ, i=1, . . . , N) can be recovered from the N complex eigenvalues of Eₓ^{†}E_{y}, which are of the form

e^{-j ω̅}^{₀}^{(Δ cos(θ}^{ᵢ}^{)/c)},i=1, . . . , N

The original ESPRIT algorithm is a time-domain based technique, where R_{zz} is approximated by a time average

$${R}_{zz} \approx \frac{1}{T} {\int }_{- T / 2}^{T / 2} {[ z ( t ) ] [ z ( t ) ]}^{H} d t$$

A frequency domain based approach is also possible with the ESPRIT algorithm being performed at each point in the frequency domain using the covariance matrix

R_{zz}(ω)=[Z(ω)][Z(ω)]^{H}

where Z(ω) is Fourier Transform of z(t).

Such a frequency domain approach has the advantage that the narrowband assumption placed upon the source signals is no longer necessary. However, at each frequency the N signal subspace vectors are permutated and so, without knowledge of this random permutation, combining results across frequencies becomes difficult as disclosed by H. Sawada, R. Mukai, S. Araki, and S. Makino, “A robust and precise method for solving the permutation problem of frequency-domain blind source separation,” IEEE Trans. Speech and Audio Processing, vol. 12, no. 5, pp. 530-538, September 2004.

At the same time, A. Jourjine, S. Rickard, and O. Yilmaz, “Blind separation of disjoint orthogonal signals: Demixing N sources from 2 mixtures,” IEEE International Conference on Acoustics, Speech, and Signal Processing (ICASSP '00), vol. vol. 5, pp. 2985-2988, June 2000; and O. Yilmaz and S. Rickard, “Blind separation of speech mixtures via time-frequency masking,” IEEE Trans. on Signal Processing, vol. vol. 52, no. 7, pp. 1830-1847, July 2004 disclose the DUET blind source separation algorithm which can demix N>2 signals using only 2 anechoic mixtures of the signals, providing these signals are W-disjoint orthogonal (WDO) i.e. that there is only ever at most one source active at any time-frequency point.

DUET handles this permutation problem by mapping each delay estimate to a source using a weighted histogram. DUET makes a further simplifying assumption which ESPRIT does not require. The DUET method relies on the concept of approximate W-disjoint orthogonality (WDO), a measure of sparsity which quantifies the non-overlapping nature of the time-frequency representations of the sources. This property is exploited to facilitate the separation of any number of sources blindly from just two mixtures using the spatial signatures of each source. These spatial signatures arise out of the separation of the measuring sensors which produces a relative arrival delay, δᵢ, and a relative attenuation factor, αᵢ for the i^{th} source.

Using a windowed Fourier transform

Sᵢ^{W}(ω,τ)=∫_{-∞}^{∞}W(t−τ)sᵢ(t)e^{-jωt}dt

the WDO assumption can be written as

Sᵢ^{W}(ω,τ)Sₖ^{W}(ω,τ)=0,∀ω,τ,i≠k.

Assuming all sources are W-disjoint orthogonal, at a given time-frequency point only one of the N sources will have a non-zero value. This allows DUET to perform separation using only two mixtures. Thus the equations for the mixtures can be written as follows:

$$[ \begin{matrix}{X}^{W} ( ω , τ ) \\ {Y}^{W} ( ω , τ )\end{matrix} ] = [ \begin{matrix}1 \\ {α}_{i} {e}^{- {jωδ}_{i}}\end{matrix} ] {S}_{i}^{W} ( ω , τ )$$

where sᵢ(t) is defined to be the i^{th} source measured at x(t). From this we can determine expressions for the mixing parameters at each point in the time-frequency domain of each of the mixtures X^{W}(ω,τ) and Y^{W}(ω,τ). Approximate W-disjoint orthogonality suggests that the parameters at each point are equal to or, at least, tend towards those for one source only.

$$\{ {\hat{a}}_{j} , {\hat{δ}}_{j} \} = \{ \vert \frac{{Y}^{W} ( ω , τ )}{{X}^{W} ( ω , τ )} \vert , Im ( log ( \frac{{Y}^{W} ( ω , τ )}{{X}^{W} ( ω , τ )} ) ) / ω \}$$

Note that, due to approximate nature of W-disjoint orthogonality along with the presence of noise, the mixing parameters in (9) are only estimates of the true values. If we calculated these parameter estimates at every point in time-frequency space, we would expect the results to cluster around the true values of the actual mixing parameters.

N sources produces N pairs of mixing parameters which creates N peaks in the parameter space histogram. We can then use these mixing-parameter estimates to partition the time-frequency representation of one mixture to recover the source estimates.

It may be noted that the phase is defined modulo-π in (9), with closely space sensors of maximum separation Δₘₐₓ=2c/fₘₐₓ (where fₘₐₓ is the highest frequency with non-negligible energy content and c is the propagation speed) so phase wrapping is not a problem.

### DISCLOSURE OF THE INVENTION

The present invention provides a method of blind source separation for demixing M mixtures of an arbitrary number of N signal sources (even when N>M) by:
a. decomposing the mixtures into respective sparse representations where a small number of components of a signal carry a large percentage of the energy of the signal;
b. performing analysis in local regions of the representations on the assumption that in that region only m<M sources are active to provide m sets of mixing parameter estimates and associated mixing parameter estimate weights;
c. creating a multi-dimensional weighted histogram using the mixing parameter estimates as indices into the histogram and associated weights for the weights of the histogram;
d. identifying peaks in the histogram to determine the number of sources N and their associated mixing parameters; and
e. assigning m instantaneous demixtures to m of the N output representations for each local region based on said mixing parameters.

The method further comprises converting the N output representations into the time domain.

Preferably, said sparse representations comprise one of a time-frequency or a time-scale representation.

Preferably, the mixing parameter weights comprise source energies associated with instantaneous demixing in this region.

Preferably, said identifying comprises using one of clustering or iterative thresholded peak finding.

Preferably, the associated mixing parameters for the histogram peaks are relative delay and attenuation mixing parameter estimates (\hat{α}₁,\hat{δ}₁), . . . , (\hat{α}_{N},\hat{δ}_{N}).

Preferably, said assigning comprises using a distance in mixing parameter space.

The invention can be implemented in either a batch (off-line) or iterative (real-time) versions. In the batch version, all the data is analyzed in one pass and the histogram created. Then, the histogram peaks are identified. Then, in a second pass through the data, the sources are demixed. In the iterative online version, the peaks are tracked from one time frame to the next and the demixtures created as new data comes in.

This present invention estimates the delay (equivalently the angle of arrival) and the attenuation of N WDO source signals as they pass across an ESPRIT-like array of sensor pairs using two or more mixtures. Providing each source has a unique attenuation and delay estimate, a two dimensional histogram will have N peaks corresponding to N source signals. The centre of each peak provides an accurate estimate of the actual attenuation and delay of each source. Since the attenuation and delay parameter estimation is performed at each time-frequency point, the estimates for the mixing parameters of the N sources can be used to partition the time-frequency plane into N regions where the WDO sources are active. As a result N time-frequency masks with non-zero values at active time-frequency points and zeros elsewhere can be applied to any of the mixtures to demix these N source signals.

DUET requires M=2, whereas the present invention can be seen as an extension of DUET where M>2 mixtures are available. The invention makes similar assumptions to ESPRIT as regards the layout of the sensors, namely that the sensors can be divided into two paired subarrays with each paired couplet of sensors sharing a common displacement vector.

The invention can be performed at each point in the time-frequency domain using the localised spatial covariance matrix

$${R}_{zz} ( ω , τ ) = E \{ [ \begin{matrix}{X}^{W} ( ω , τ ) \\ {Y}^{W} ( ω , τ )\end{matrix} ] [ {\begin{matrix}{{X}^{W} ( ω , τ )}^{H} & {Y}^{W} ( ω , τ )\end{matrix}}^{H} ] \}$$

the singular value decomposition of R_{zz}(ω,τ) at each time-frequency point is of the form

$${R}_{zz} ( ω , τ ) = {[ \begin{matrix}{E}_{x} & {E}_{{n}_{x}} \\ {E}_{y} & {E}_{{n}_{y}}\end{matrix} ] [ \begin{matrix}Λ & 0 \\ 0 & Σ\end{matrix} ] [ \begin{matrix}{E}_{x} & {E}_{{n}_{x}} \\ {E}_{y} & {E}_{{n}_{y}}\end{matrix} ]}^{H}$$

From equation (6) Φ may be recovered via an eigenvalue decomposition

Φ(ω,τ)=T[E_{X}^{†}(ω,τ)E_{Y}(ω,τ)]T⁻¹

at a given time-frequency point, up to N signals may be present and the resulting N-by-N diagonal matrix Φ(ω,τ) has up to N non-zero entries which are of the form

φᵢ=αᵢe^{-jωδ}^{ᵢ},i=1, . . . , N

where αᵢ and δᵢ are the relative attenuation and delay parameters for the i^{th} source. Note, this is an extension of the diagonal matrix used in the ESPRIT algorithm discussed above including relative attenuation scaling factors αᵢ in addition to the associated phase factors stemming from the relative delays δᵢ.

It is discussed in the background how the DUET BSS algorithm constructs a two dimensional histogram of these parameters to identify any number of sources and ultimately separate them if they can be assumed to strongly W-disjoint orthogonal. By borrowing from both techniques the present invention is possible.

Under a weakened WDO assumption with possibly M−1 sources overlapping at any point in the time-frequency domain, the parameter estimation step of DUET fails. However, the present invention continues to work well providing that the number of sensors in the ESPRIT-like uniform linear array outnumber the number of sources that may coexist at a particular region in the time-frequency domain.

In a first embodiment, the invention operates under the DUET strong WDO assumption (at most one source is active for every time-frequency point), whereas in a second embodiment, the invention operates under a weakened WDO assumption.

### BRIEF DESCRIPTION OF THE DRAWINGS

Embodiments of the invention will now be described by way of example with reference to the accompanying drawings, in which:

FIG. 1 shows blind source separation of 4 signals from 3 anechoic mixtures using a first embodiment of the present invention;

FIG. 2 shows the parameter histograms for conventional 2 channel; as well as 3 and 4 multi-channel implementations of the first embodiment at Signal to Noise Ratios of 0 dB, 5 dB and 10 dB (columns 1, 2 and 3);

FIG. 3 shows weighted parameter histograms associated with high, medium and low instantaneous power estimates;

FIG. 4 shows blind source separation using a second embodiment of the invention for 5 speech signals (top left); 4 anechoic mixtures (top right); 2D-histogram (bottom left) and 5 demixed signals (bottom right); and

FIG. 5 shows blind source separation using a further embodiment of the invention for 2 speech signals travelling upon 3 and 2 echoic paths respectively (top left); 6 echoic mixtures of the two signals (top right); a 2D power weighted histogram showing 5 peaks (bottom left); and 5 demixed signals recovered, 3 corresponding to the first signal and 2 corresponding to the second signal (bottom right).

### DESCRIPTION OF THE PREFERRED EMBODIMENTS

In the first embodiment, where the invention operates under a strong WDO assumption Λ is a 1-by-1 scalar λ, Σ has all near zero entries and

$$[ \begin{matrix}{E}_{x} ( ω , τ ) \\ {E}_{y} ( ω , τ )\end{matrix} ]$$

is a 2 m-by-1 vector so as a result the scalar φ is given by

φ=E_{X}(ω,τ)^{†}E_{X}(ω,τ)^{†}

Furthermore when the expectation operator of equation (10) is approximated by an instantaneous estimate, i.e.

$${R}_{zz} ( ω , τ ) = [ \begin{matrix}{X}^{W} ( ω , τ ) \\ {Y}^{W} ( ω , τ )\end{matrix} ] [ {\begin{matrix}{{X}^{W} ( ω , τ )}^{H} & {Y}^{W} ( ω , τ )\end{matrix}}^{H} ]$$

the expression (11) is equivalent to

φ=X^{W}(ω,τ)^{†}Y^{W}(ω,τ)

and so in this case the subspace decomposition of the spatial covariance matrix is unnecessary. In the M=2 case this implementation reduces to conventional DUET. Thus, the present invention applies to multichannel (M>2) implementations of this embodiment.

The steps involved in the multichannel implementation of the first embodiment are as follows:

### Step 1

A uniformly spaced linear array of M sensors receives M anechoic mixtures x₁(t), x₂(t), . . . , x_{M}(t), of N WDO source signals. These M signals are represented in the 2(M−1)-by-1 time-varying vector

$$z ( t ) = [ \begin{matrix}x ( t ) \\ y ( t )\end{matrix} ]$$

where x(t)=(x₁(t), x₂(t), . . . , x_{M-}(t))^{T} and y(t)=(x₂(t), x₃(t), . . . , x_{M}(t))^{T} represent signals taken from the first and second subarrays respectively. K samples are taken at t=kT, k=0, 1, . . . , K−1, where T is the sampling period.

### Step 2

A window W(t), of length L is formed and by shifting the position of the window by multiples of Δ seconds, localisation in time is possible.

for τ = 0 : Δ : (K − 1)T
z(t,τ) = W(t − τ)z(t)
Z(ω,τ) = DFT(z(t,τ))
for ω = (0 : 1 : L − 1) × 2π / LT
φ(ω,τ) = X(ω, τ)^{†}Y(ω,τ)
α(ω,τ) = |φ(ω, τ)|
δ(ω,τ) = −Im(logₑ (φ(ω,τ))) / ω
end
end

### Step 3

A two dimensional histogram of the attenuation and delay parameters (α(ω,τ) and δ(ω,τ)) is constructed, weighting of histogram values is possible using X^{W}(ω,τ)^{H}X^{W}(ω,τ) which is proportional to the power of the source present at each time-frequency point. N histogram peaks indicate N source signals, the (α,δ) values corresponding to the centre of each peak are mapped back into the time-frequency domain to indicate in which regions each of the N source signals are active. Peak Detection is performed using a weighted K-means based technique or an iterated peak removal technique.

### Step 4

Under the assumption that the N source signals are strongly W-disjoint orthogonal, a binary time-frequency mask corresponding to the regions of the time-frequency plane where a source is active is created. Applying the i^{th} mask to any of the received mixtures recovers the i^{th} source signal. N such masks are used to separate the N sources.

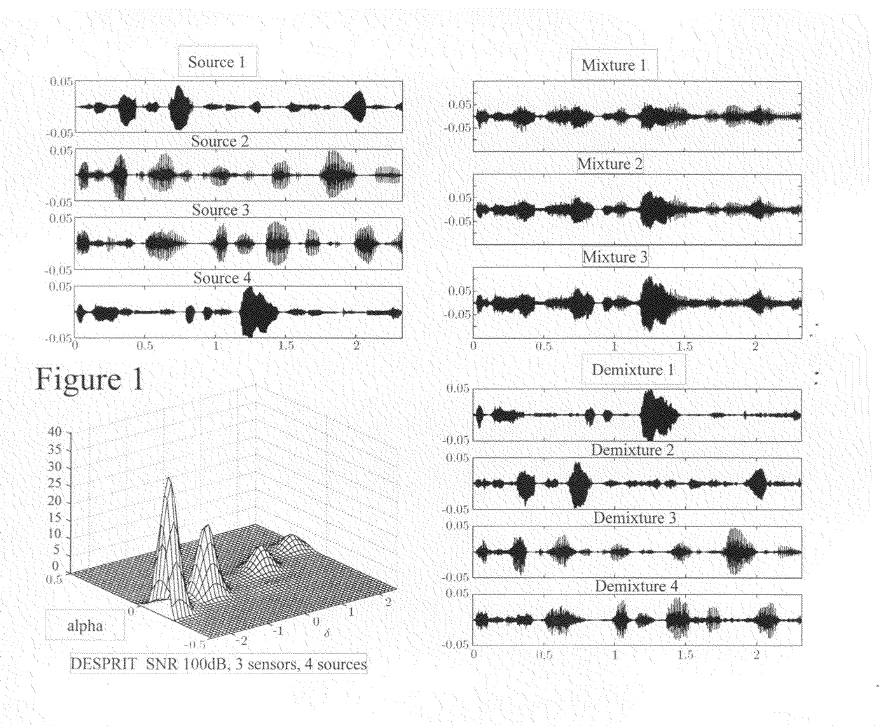

As an example of the results provided by the above embodiment, the implementation was used to blindly demix four 2.4 seconds long speech signals, using three anechoic mixtures of these signals each having been sampled at 16 kHz. Plots of the original source signals, the received mixtures, the two-dimensional histogram and the demixed signals are given in FIG. 1, a high SNR of 100 dB is assumed.

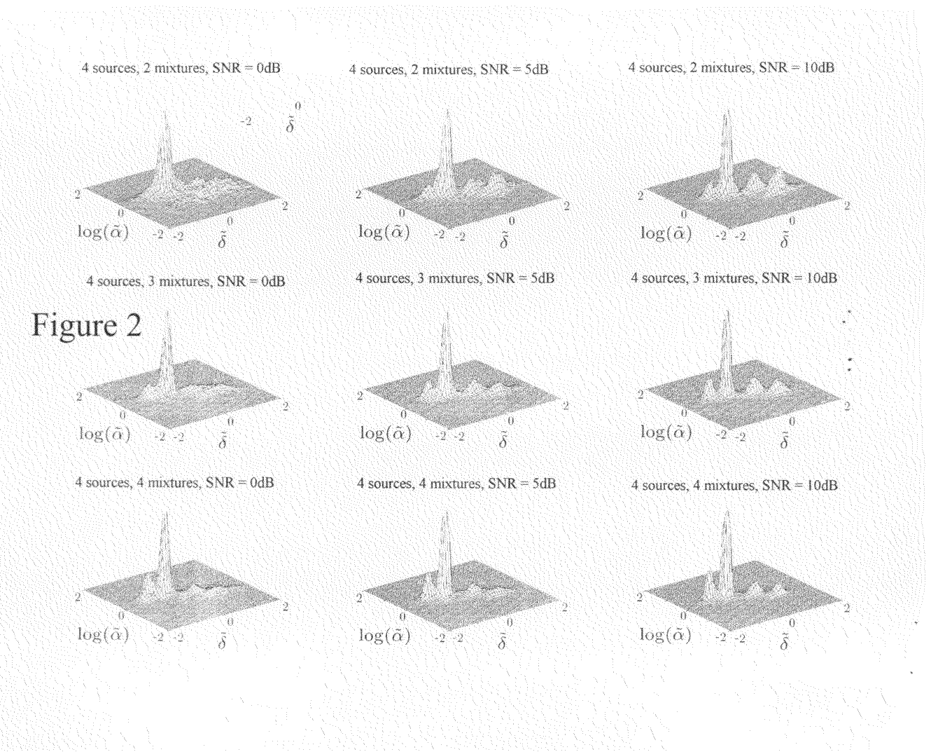

The multichannel implementation (M>2) above can be compared with the classic implementation of DUET (M=2) for the same data as before under noisier conditions. The invention has clear advantages at lower values of Signal to Noise Ratios (SNRs) since an increase in the number of sensors improves parameter estimation when using the invention. FIG. 2 shows the parameter histograms for conventional 2 channel; as well as 3 and 4 multi-channel implementations at Signal to Noise Ratios of 0 dB, 5 dB and 10 dB (columns 1, 2 and 3).

A second embodiment of the invention is based on a weak-WDO assumption that allows for more than one source to have significant energy in the same time-frequency coefficient.

In this embodiment, ESPRIT direction of arrival (as well as attenuation) estimation is performed at each time-frequency point by considering a group of neighbouring time frames for a given frequency. As in DUET, the estimated mixing parameters are used to create a two-dimensional weighted histogram. The weights for the histogram are obtained from the energy of the time-frequency localized demixtures found by applying a demixing matrix based on the mixing parameters estimates for that time-frequency point.

From the histogram, N peaks are located corresponding to the N source mixing parameter pairs. Demixing is performed by matrix inversion at each time-frequency point, assigning the resulting demixtures based on the distance to the known source mixing parameters.

In more detail:

### Step 1

A uniform linear array of M sensors receives M anechoic mixtures of N weak-WDO, possibly wideband source signals. These M mixture signals are stacked in a 2 m-by-1 time-varying vector

$$z ( t ) = [ \begin{matrix}x ( t ) \\ y ( t )\end{matrix} ]$$

where m=M−1 and the m mixtures x(t) are the first m mixtures of z(t) and the m mixtures y(t) are the last m mixtures of z(t).

### Step 2

K samples of z(t) are taken at t=kT, k=0, 1, . . . , K−1, where T is the sampling period. A window W(t) of length L<<(K−1)T is formed and by shifting the position of the window by multiples of Δ seconds, localisation in time is possible.

for τ= 0 : Δ : (K − 1)T do
for k = τ − mT : Δ : τ + mT do
Z(ω, k) = DFT(W(t − k)z(t))
end
for ω = (0 : 1 : L −1) × 2π / LT
$R ( ω , τ ) = \frac{1}{2 m} {\sum }_{k = r - mT}^{k = r + mT} {[ Z ( ω , k ) ] [ Z ( ω , k ) ]}^{H}$
${[ U ( ω , τ ) ] [ D ( ω , τ ) ] [ U ( ω , τ ) ]}^{H} {=}^{SVD} R ( ω , τ )$
$[ \begin{matrix}{E}_{x} ( ω , τ ) \\ {E}_{y} ( ω , τ )\end{matrix} ] = first m columns \{ U ( ω , τ ) \}$
${{E}_{x} ( ω , τ )}^{†} {E}_{y} ( ω , τ ) { }^{Eigenvalue Decomposition} [ \begin{matrix}{φ}_{1} ( ω , τ ) & & \\ & ⋱ & \\ & & {φ}_{m} ( ω , τ )\end{matrix} ]$
${\tilde{δ}}_{1} ( ω , τ ) = \frac{- Im \{ {log}_{e} \{ {φ}_{i} ( ω , τ ) \} \}}{ω} , {\tilde{α}}_{i} ( ω , τ ) = \vert {φ}_{i} ( ω , τ ) \vert$
$[ \begin{matrix}{\tilde{S}}_{1} ( ω , τ ) \\ {\tilde{S}}_{2} ( ω , τ ) \\ ⋮ \\ {\tilde{S}}_{m} ( ω , τ )\end{matrix} ] = [ \begin{matrix}{φ}_{1}^{0} & {φ}_{2}^{0} & … & {φ}_{m}^{0} \\ {φ}_{1}^{1} & {φ}_{2}^{1} & … & {φ}_{m}^{1} \\ ⋮ & ⋮ & & ⋮ \\ {φ}_{1}^{2 m - 1} & {φ}_{2}^{2 m - 1} & … & {φ}_{m}^{2 m - 1}\end{matrix} ] [ Z ( ω , τ ) ]$
end
end

### Step 3

The m attenuation \tilde{α}ᵢ(ω,τ) and delay \tilde{δ}ᵢ(ω,τ)parameters and m source signal Estimates \tilde{S}₁(ω,τ), . . . , \tilde{S}ₘ(ω,τ) are produced at each of the LKT/Δ time-frequency points and then used to create a 2-D power weighted histogram. Unlike a count histogram a weighted histogram increments each bin by a weight associated with each different estimate instead of incrementing by unity for each estimate. We have weighted each {\tilde{α}ᵢ(ω,τ), \tilde{δ}ᵢ(ω,τ)} estimate by the associated instantaneous power |\tilde{S}ᵢ(ω,τ)|²i=1, . . . , m for high SNR values estimates associated with an actual source will be given a large weight and estimates associated with noise values will be given a small weight. As in DUET, the N histogram peaks indicate N source signals.

Peak detection is performed using a weighted K-means based technique which produces N mixing parameter estimates (\hat{α}ᵢ, \hat{δ}ᵢ), i=1, . . . , N.

### Step 4

Each of the m instantaneous source estimates \tilde{S}₁(ω,τ), . . . , \tilde{S}ₘ(ω,τ) needs to be correctly assigned to one of the N demixed source estimates at each time-frequency point. Assignment is performed by determining which of the m instantaneous parameter estimates

((\tilde{α}₁(ω,τ),\tilde{δ}₁(ω,τ)), . . . , (\tilde{α}ₘ(ω,τ),(\tilde{δ}ₘ(ω,τ)))

is closest to each of the N peak centres (\hat{α}₁, \hat{δ}₁), . . . , (\hat{α}_{N}, \hat{δ}_{N}).

Preferably, said measure of closeness of the i^{th} estimate at (ω,τ) to the k^{th} peak centre is given as

$$\{ {\vert \frac{{\tilde{α}}_{i} ( ω , τ ) - {\hat{α}}_{k}}{{m}_{α}} \vert}^{2} + {\vert \frac{{\tilde{δ}}_{i} ( ω , τ ) - {\hat{δ}}_{k}}{{m}_{δ}} \vert}^{2} \}$$

where m_{α} and m_{δ} are normalising factors. Beginning with the instantaneous mixing parameter estimates associated with the instantaneous source estimates of lowest power, at each time-frequency point the closest peak centre is found and the lowest power instantaneous source estimate is assigned to the appropriate demixed source estimate. The assignment is then carried out for the instantaneous mixing parameter estimates associated with the instantaneous source estimates of next lowest power and so on. Assignments carried out in later stages are allowed to overwrite previous assignments in the belief that the instantaneous mixing parameter estimates associated with the instantaneous signal estimates of greater power are the more reliable, since they have been affected by noise the least. The N demixed source estimates are then synthesised back into the time-domain.

As discussed, the WDO assumption used by DUET assumes that there is only ever one, source active at any time-frequency point. The second embodiment of the present invention uses an eigenvalue decomposition step to uncover m=M−1 possible parameter estimates.

Table 1 shows the percentage of the average instantaneous power associated with each of the 3 possible parameter estimates, with one source present the strongest eigenvalue is weighted by about 99.36% of the power and the next strongest eigenvalue is weighted by the remaining 0.64% of the power. As the number of sources increases the WDO assumption is weakened since the strongest eigenvalue receives weaker associated power weighting and the secondary and tertiary eigenvalues receive stronger weightings.

TABLE 1
The percentage of the average instantaneous signal power
associated with the eigenvalues φ1, φ2, and φ3, sorted according
to highest associated signal power, when 2, 3, . . . , 5 sources and
no noise are present.

| | φ1 | φ2 | φ3 |
|---|---|---|---|
| 2 sources | 96.393 | 3.4794 | 0.1276 |
| 3 sources | 91.831 | 7.3426 | 0.8261 |
| 4 sources | 90.831 | 7.9957 | 1.1734 |
| 5 sources | 86.820 | 11.440 | 1.7404 |

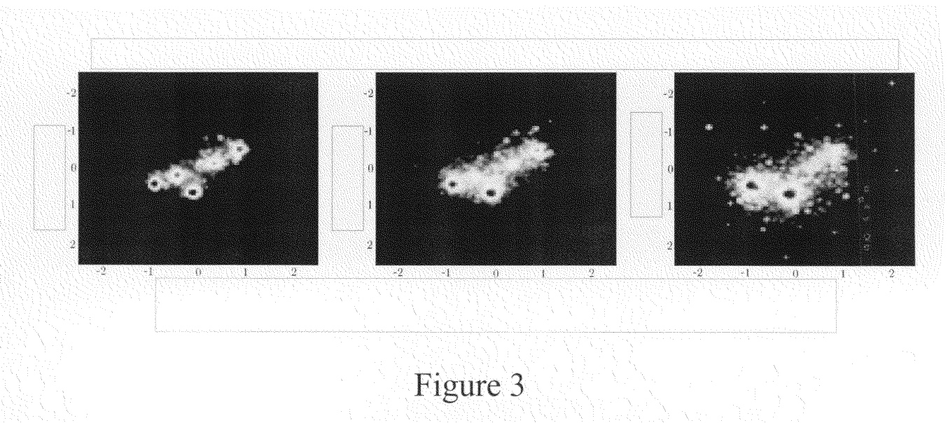

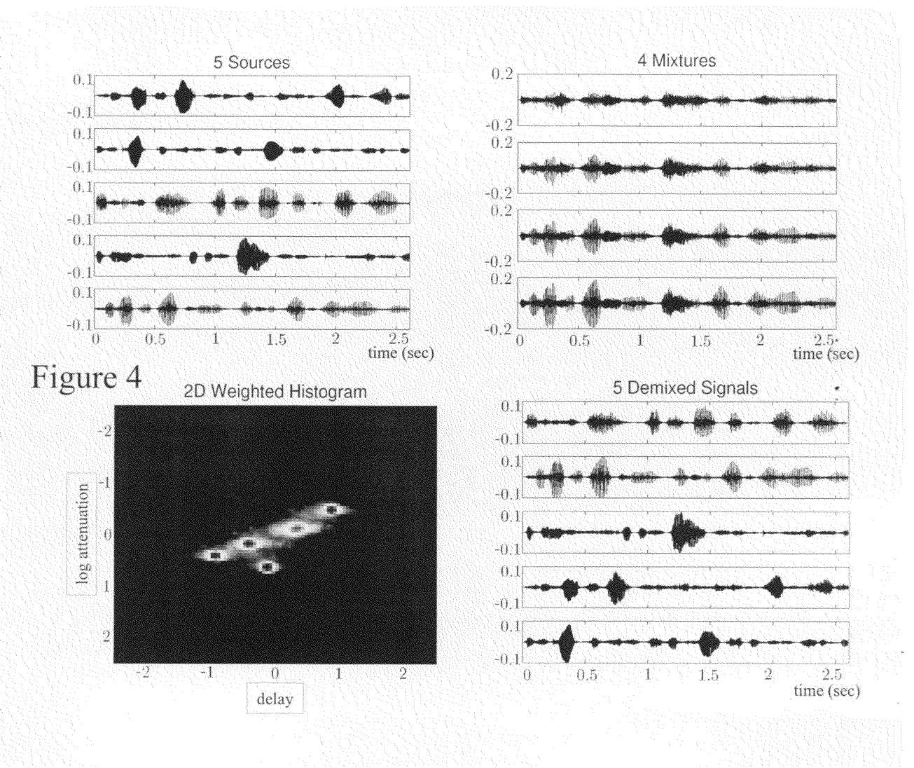

The second embodiment was used to blindly demix five 1.7 seconds long speech signals, using four anechoic mixtures of these signals each having been sampled at 16 kHz. FIG. 3 shows the two-dimensional histograms associated with high, medium and low power estimates. Operating under a strong WDO assumption the first embodiment has access only to the first histogram, whereas the invention operating under a weakened WDO assumption has access all 3 and so a single histogram containing 3 times the data may be constructed. Plots of the original source signals, the received mixtures, the two-dimensional histogram and the demixed signals are given in FIG. 4.

In variations of the above embodiments, the invention may be applied to echoic environments. This is based on stacking M mixtures {x₁(t), x₂(t), . . . , x_{M}(t)} of N possibly coherent narrowband source signals {s₁(t), s₂(t), . . . , s_{N}(t)} of centre frequency ω₀ in a matrix of the form:

$$z ( t ) = [ \begin{matrix}{x}_{1} ( t ) & {x}_{2} ( t ) & … & {x}_{⌊ M / 2 ⌋} ( t ) \\ ⋮ & ⋮ & & ⋮ \\ {x}_{⌈ M / 2 ⌉} ( t ) & {x}_{⌈ M / 2 ⌉ + 1} ( t ) & … & {x}_{M - 1} ( t ) \\ {x}_{2} ( t ) & {x}_{3} ( t ) & … & {x}_{⌊ M / 2 ⌋ + 1} ( t ) \\ ⋮ & ⋮ & & ⋮ \\ {x}_{⌈ M / 2 ⌉ + 1} ( t ) & {x}_{⌈ M / 2 ⌉ + 2} ( t ) & … & {x}_{M} ( t )\end{matrix} ]$$

where ┌ ┐ and └ ┘ denote rounding up and down to the nearest integer.

In a no noise case this may be rewritten as:

$$z ( t ) = [ \begin{matrix}A ( {ω}_{0} ) \\ A ( {ω}_{0} ) Φ ( {ω}_{0} )\end{matrix} ] Ψ ( {ω}_{0} ) s ( t )$$

$$where \text{:}$$

$$Ψ ( {ω}_{0} ) = [ \begin{matrix}1 & {φ}_{1} ( {ω}_{0} ) & … & {φ}_{1}^{⌊ M / 2 ⌋ - 1} ( {ω}_{0} ) \\ ⋮ & ⋮ & & ⋮ \\ 1 & {φ}_{N} ( {ω}_{0} ) & … & {φ}_{N}^{⌊ M / 2 ⌋ - 1} ( {ω}_{0} )\end{matrix} ]$$

The spatial covariance matrix:

R_{zz}=E{z(t)z^{H}(t)}

is of the form:

$$= E \{ s ( t ) {s}^{*} ( t ) \} [ \begin{matrix}A ( {ω}_{0} ) \\ A ( {ω}_{0} ) Φ ( {ω}_{0} )\end{matrix} ] Ψ ( {ω}_{0} ) {{Ψ}^{H} ( {ω}_{0} ) [ \begin{matrix}A ( {ω}_{0} ) \\ A ( {ω}_{0} ) Φ ( {ω}_{0} )\end{matrix} ]}^{H}$$

and by choosing M≧2N, R_{zz} will have a maximum possible rank of N. For R_{zz} of rank N there exists a singular value decomposition:

$${R}_{zz} = {[ \begin{matrix}{E}_{1} \\ {E}_{2}\end{matrix} ] [ \begin{matrix}{λ}_{1} & & \\ & ⋱ & \\ & & {λ}_{N}\end{matrix} ] [ \begin{matrix}{E}_{1} \\ {E}_{2}\end{matrix} ]}^{H}$$

and it follows that the N eigenvalues of:

[E₁]⁻¹[E₂]

are the mixing parameters {(φ₁, φ₂, . . . , φ_{N}}.

In general, the steps involved in implementing this variation are as follows:

M narrowband mixtures {x₁(t), x₂(t), . . . , x_{M}(t)} are used to construct the matrices

$${E}_{1} = [ \begin{matrix}{x}_{1} ( t ) & … & {x}_{⌊ M / 2 ⌋} ( t ) \\ ⋮ & & ⋮ \\ {x}_{⌈ M / 2 ⌉} ( t ) & … & {x}_{M - 1} ( t )\end{matrix} ] , \\ {E}_{2} = [ \begin{matrix}{x}_{2} ( t ) & … & {x}_{⌊ M / 2 ⌋ + 1} ( t ) \\ ⋮ & & ⋮ \\ {x}_{⌈ M / 2 ⌉ + 1} ( t ) & … & {x}_{M} ( t )\end{matrix} ]$$

The └M/2┘ mixing parameters estimates are obtained via an eigenvalue decomposition:

(\tilde{φ}₁(ω₀), . . . , \tilde{φ}_{└M/2┘}(ω₀))=eigs{E₂E₁^{†}}.

Now, a uniform linear array of M sensors may be used to estimate the mixing parameters of one signal travelling on P echoic paths, providing M≧2P. This allows M echoic mixtures of an arbitrary number of speech source signals to be demixed providing the maximum number of echoic paths no more than half the number of sensors in the uniform linear array.

More particularly, the steps involved are as follows:

Step 1: A uniform linear array of M sensors receives M possibly echoic mixtures {x₁(t), x₂(t), . . . , x_{M}(t)} of N speech signals. These M mixture signals are sampled every T seconds and a window W(t) of length L<<KT seconds is shifted by multiples of ΔT seconds to perform K/Δ L-point Discrete Windowed Fourier Transforms upon K samples of each mixture. At the time-frequency point (ω,τ) the 1^{st} mixture is given as:

$${X}_{1} ( ω , τ ) = {\sum }_{k = 0}^{K - 1} W ( kT - τ ) {x}_{1} ( kT ) {e}^{- jω kT}$$

where W(t) is chosen such that the class of source signals of interest satisfy the W-disjoint orthogonal assumption as much as possible, for speech W(t) is chosen to be an L=30 millisecond long Hamming window and Δ=L/2T.

### Step 2:

At each time-frequency point the new ESPRIT parameter estimation step is performed, the └M/2┘ estimated mixing parameters are used to perform a demixing step at each time-frequency point via an inversion of the estimated mixing matrix and the Moore-Penrose pseudo-inverse [ ]^{†} is used to invert non-square matrices. At the time-frequency point (ω,τ) the └M/2┘ mixing parameters are given as:

$${E}_{1} = [ \begin{matrix}{x}_{1} ( ω , τ ) & … & {x}_{⌊ M / 2 ⌋} ( ω , τ ) \\ ⋮ & & ⋮ \\ {x}_{⌈ M / 2 ⌉} ( ω , τ ) & … & {x}_{M - 1} ( ω , τ )\end{matrix} ]$$

$${E}_{2} = [ \begin{matrix}{x}_{2} ( ω , τ ) & … & {x}_{⌊ M / 2 ⌋ + 1} ( ω , τ ) \\ ⋮ & & ⋮ \\ {x}_{⌈ M / 2 ⌉ + 1} ( ω , τ ) & … & {x}_{M} ( ω , τ )\end{matrix} ]$$

$$( {\tilde{φ}}_{1} , … , {\tilde{φ}}_{⌊ M / 2 ⌋} ) = eigs \{ {[ {E}_{2} ] [ {E}_{1} ]}^{†} \}$$

### Step 3:

At each time-frequency point and for i=1, 2, . . . , └M/2┘ the relative attenuation and delay mixing parameter estimates are calculated:

$${\tilde{α}}_{i} ( ω , τ ) = \vert {\tilde{φ}}_{i} ( ω , τ ) \vert , {\tilde{δ}}_{i} ( ω , τ ) = \frac{- Im \{ {log}_{e} \{ {\tilde{φ}}_{i} ( ω , τ ) \} \}}{ω}$$

an A×D two-dimensional power weighted histogram H_{αδ} of the relative attenuation and delay parameters is also constructed, i.e. a histogram is constructed in the usual way but instead of a bin being incremented by one when a mixing parameter estimate is entered into the histogram, each the signal power associated with the estimate is added.

### Step 4:

The power weighted histogram H_{αδ} will have a number of peaks N′≧N each represents a signal received by the sensor array, in an echoic environment some of these signals may have the originated from the same source. The centres of each of the peaks provide estimates of the mixing parameters (\hat{α}₁, \hat{δ}₁), . . . , (\hat{α}_{N′}, \hat{δ}_{N′}). Peak detection may be performed using a suitable clustering technique.

### Step 5:

The permutation ambiguity associated with wideband implementations of narrowband techniques is overcome when each of the └M/2┘ instantaneous source estimates:

$$[ \begin{matrix}{\tilde{S}}_{1} ( ω , τ ) \\ ⋮ \\ {\tilde{S}}_{⌊ M / 2 ⌋} ( ω , τ )\end{matrix} ] = [ \begin{matrix}1 & … & 1 \\ {\tilde{φ}}_{1} ( ω , τ ) & … & {\tilde{φ}}_{⌊ M / 2 ⌋} ( ω , τ ) \\ ⋮ & & ⋮ \\ {\tilde{φ}}_{1}^{M - 1} ( ω , τ ) & … & {\tilde{φ}}_{⌊ M / 2 ⌋}^{M - 1} ( ω , τ )\end{matrix} ] [ \begin{matrix}{X}_{1} ( ω , τ ) \\ ⋮ \\ {X}_{M} ( ω , τ )\end{matrix} ]$$

is correctly assigned to one of the N′≧N demixed estimates at each time-frequency point. Assignment is performed by determining which of the └M/2┘ instantaneous parameter estimates:

((\tilde{α}₁(ω,τ),\tilde{δ}₁(ω,τ)), . . . , (\tilde{α}_{└M/2┘}(ω,τ),\tilde{δ}_{└M/2┘}(ω,τ)))

is closest to each of the N′≧N peak centres (\hat{α}₁,\hat{δ}₁), . . . , (\hat{α}_{N′},\hat{δ}_{N′}). The measure of closeness of the i^{th} estimate at (ω,τ) to the n^{th} peak centre is given as:

$$\{ {\vert \frac{{\tilde{α}}_{i} ( ω , τ ) - {\hat{α}}_{k}}{{N}_{α}} \vert}^{2} + {\vert \frac{{\tilde{δ}}_{i} ( ω , τ ) - {\hat{δ}}_{k}}{{N}_{δ}} \vert}^{2} \}$$

where N_{α} and N_{δ} are normalising factors. Beginning with the instantaneous mixing parameter estimates associated with the instantaneous source estimates of lowest power, at each time-frequency point the closest peak centre is found and the lowest power instantaneous source estimate is assigned to the appropriate demixed source estimate. The assignment is then carried out for the instantaneous mixing parameter estimates associated with the instantaneous source estimates of next lowest power and so on. Assignments carried out in later stages are allowed to overwrite previous assignments in the belief that the instantaneous mixing parameter estimates associated with the instantaneous signal estimates of greater power are the more reliable, since they have been affected by noise the least. The N′≧N demixed source estimates are then synthesised back into the time-domain.

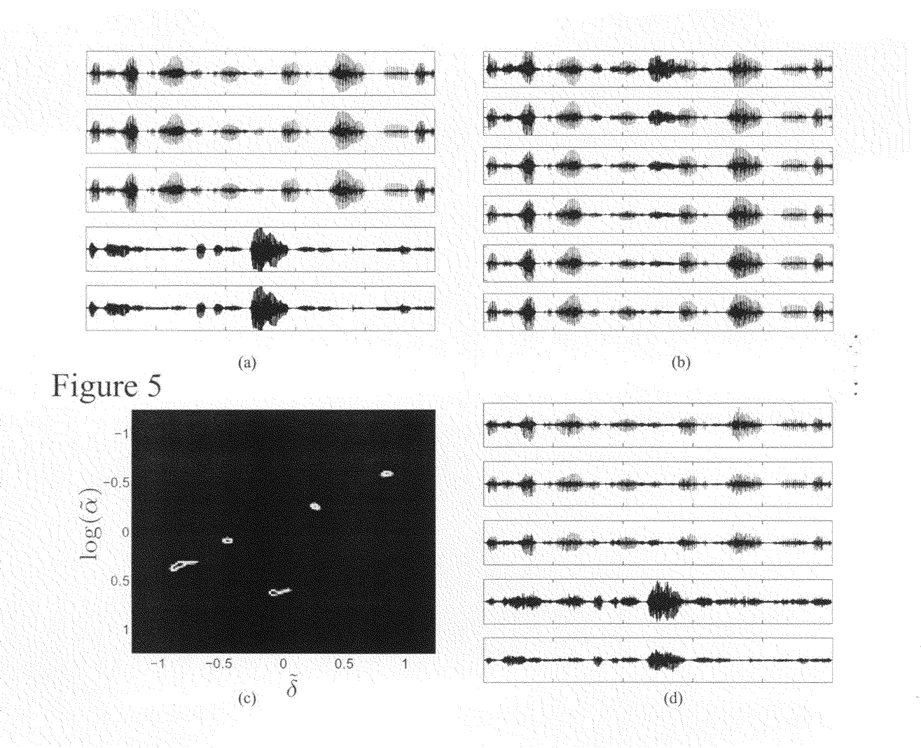

FIG. 5 shows blind source separation using the above embodiment of the invention for 2 speech signals travelling upon 3 and 2 echoic paths respectively (top left); 6 echoic mixtures of the two signals (top right); a 2D power weighted histogram showing 5 peaks (bottom left); and 5 demixed signals recovered, 3 corresponding to the first signal and 2 corresponding to the second signal (bottom right).

In other variations of the invention, the weighted histogram approach of the DUET aspect of the above embodiments may be used in combination with other direction of arrival algorithms other than ESPRIT such as the MUSIC algorithm.

In other variations of the invention, standard square mixing (N=M) or over-determined mixing (N<M) blind source separation techniques can be used in the local regions to determine the mixing parameters and instantaneous demixture weights for the histogram.

In other variations of the invention, the histogram has more than two-dimensions which allows for the sensors to be in arbitrary arrangements.

In other variations of the invention, mixing parameter estimates and mapped to a domain in which their value corresponds to physical location of the source and the weighted histogram constructed yields information about relative locations of the sources in addition as providing the means for separation.

It will be seen that the invention is useful in several applications, where the ability to separate underlying signals for their mixtures is of critical importance. For example, the ability to separate out one speaker from a number of speakers has applications in hearing aids; the ability to separate out a number of speakers from a mixture has application for automatic meeting transcription, monitoring or audio forensics; the ability to separate out the original sources of sound (valves, murmurs, etc. . . ) from biomedical signals including heart sounds has diagnostic value for physicians (EEG, ECG, PCG, MEG); and the ability to demultiplex wireless signals based on their spatial signature (frequency-hopped waveforms) could result in improved multi-access wireless systems; other signals which could be processed include seismic signals or other terrestrial mapping signals, optics and optical signal transmissions, and optical and radio signals from space.

1. A method of blind source separation for demixing M mixtures of an arbitrary number of N signal sources comprising the steps of:
a. decomposing the mixtures into respective sparse representations where a small number of components of a signal carry a large percentage of the energy of the signal;
b. performing analysis in local regions of the representations on the assumption that in that region only m<M sources are active to provide m sets of mixing parameter estimates and associated mixing parameter estimate weights;
c. creating a multi-dimensional weighted histogram using the mixing parameter estimates as indices into the histogram and associated weights for the weights of the histogram;
d. identifying peaks in the histogram to determine the number of sources N and their associated mixing parameters; and
e. assigning m instantaneous demixtures to m of the N output representations for each local region based on said mixing parameters.

2. A method according to claim 1 wherein said mixtures are anechoic and where N>M.

3. A method according to claim 1 wherein said mixtures are echoic and where M≧2N.

3. A method according to claim 1 further comprising: converting the N output representations into the time domain.

4. A method according to claim 1 wherein said sparse representations comprise one of a time-frequency or a time-scale representation.

5. A method according to claim 1 wherein the mixing parameter weights comprise source energies associated with instantaneous demixing in this region.

6. A method according to claim 1 wherein said identifying comprises using one of clustering or iterative thresholded peak finding.

7. A method according to claim 1 wherein the associated mixing parameters for the histogram peaks are relative delay and attenuation mixing parameter estimates: (\hat{α}₁, \hat{δ}₁), . . . , (\hat{α}_{N′}, \hat{δ}_{N′}).

8. A method according to claim 1 wherein said assigning comprises using a distance in mixing parameter space.
